(19) United States
(12) Patent Application Publication
(10) Pub. No.: US 2026/0064191 A1
(43) Pub. Date: Mar. 5, 2026

(54) SYSTEM

(71) Applicant: SoftBank Group Corp., Tokyo (JP)

(72) Inventor: Anju YAMAMOTO, Tokyo (JP)

(21) Appl. No.: 19/302,173

(22) Filed: Aug. 18, 2025

(30) Foreign Application Priority Data
Aug. 30, 2024 (JP) 2024-150013

(51) Int. Cl. G06F 3/01

(52) U.S. Cl. CPC G06F 3/011; G06F 2203/011

(57) ABSTRACT

The system according to the embodiment comprises a collection unit, an analysis unit, a decision unit, and an execution unit. The collection unit collects the state of the user. The analysis unit analyzes data collected by the collection unit. The decision unit determines an appropriate operation based on the analysis result obtained by the analysis unit. The execution unit executes the operation determined by the decision unit.

### CROSS-REFERENCE TO RELATED APPLICATION

The present application claims priority to and incorporates by reference the entire contents of Japanese Patent Application No. 2024-150013 filed in Japan on Aug. 30, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that, in operating a smart home, the user needs to give instructions to a smartphone or smart speaker, which can be bothersome.

### SUMMARY OF THE INVENTION

The system according to the embodiment comprises a collection unit, an analysis unit, a decision unit, and an execution unit. The collection unit collects the state of the user. The analysis unit analyzes data collected by the collection unit. The decision unit determines an appropriate operation based on the analysis result obtained by the analysis unit. The execution unit executes the operation determined by the decision unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

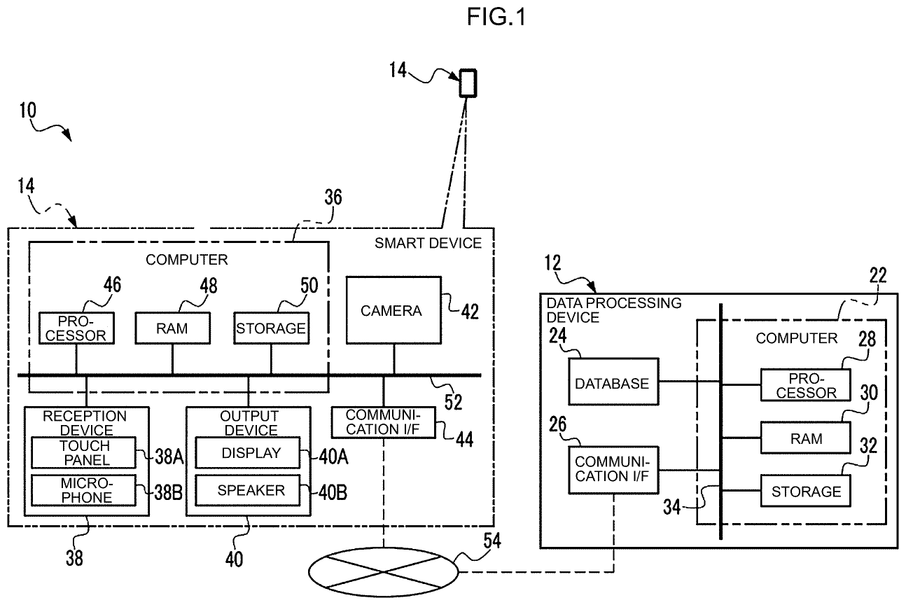

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

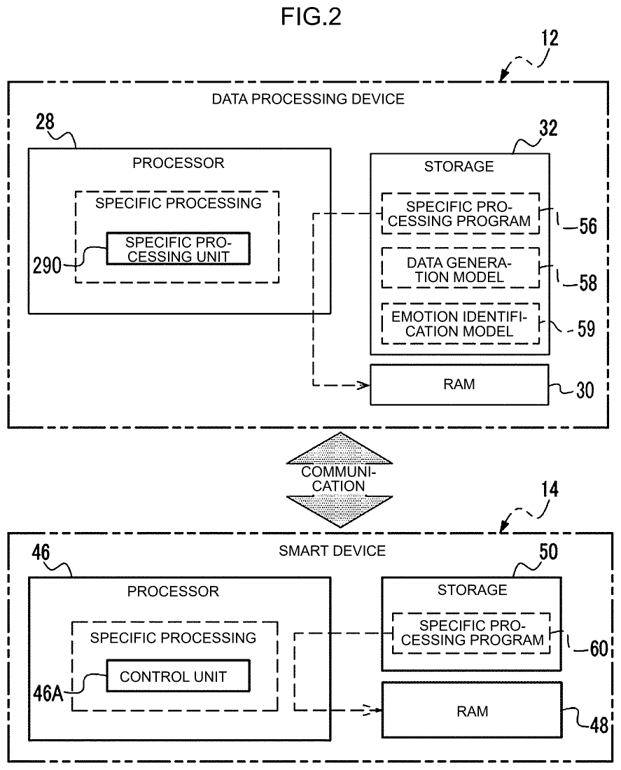

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The smart home system according to the embodiment of the present invention is a smart home system that does not require instructions via a smart speaker equipped with a camera and generative AI. This smart home system collects the user's state using a camera installed in the smart speaker, and the generative AI analyzes the data to recognize the user's behavior. Based on the analysis result, the generative AI determines the optimal operation and autonomously performs actions such as playing music. As a result, the user can enjoy a comfortable environment without operating a smartphone or speaking to the speaker. Furthermore, the system also has a function to learn the user's behavior patterns and provide the optimal environment according to the time of day and situation. In addition, to protect privacy with the camera, mechanisms for data encryption and obtaining user consent are also included. For example, the user's state is collected by a camera installed in the smart speaker. For example, the camera captures the user relaxing in the living room. This data is sent to the generative AI. Next, the generative AI analyzes the collected data and recognizes the user's behavior. For example, if it determines that the user is relaxing, the generative AI selects music suitable for that situation. Based on the analysis result, the generative AI determines the optimal operation. For example, it decides to play relaxing music for a relaxing user. The determined operation is executed. For example, the smart speaker plays music. In this way, the user can enjoy a comfortable environment without any operation. Furthermore, the generative AI learns the user's behavior patterns and provides the optimal environment according to the time of day and situation. For example, it plays relaxing music at night and awakening music in the morning. In addition, to protect privacy with the camera, mechanisms for data encryption and obtaining user consent are also included. For example, the collected data is encrypted and analyzed only after obtaining the user's consent. In this way, the smart home system can provide a smart home that requires no operation by automatically collecting, analyzing, determining, and executing based on the user's state.

The smart home system according to the embodiment comprises a collection unit, an analysis unit, a decision unit, and an execution unit. The collection unit collects the state of the user. The user's state may include, for example, actions, facial expressions, and voice, but is not limited thereto. The collection unit may collect the user's actions using a camera, for example. The collection unit may also collect the user's voice using a microphone. Furthermore, the collection unit may collect the user's facial expressions using a sensor. For example, the collection unit may collect the user's actions in real time using a camera and send them to the generative AI. The collection unit may also collect the user's voice using a microphone and send it to the generative AI. Furthermore, the collection unit may collect the user's facial expressions using a sensor and send them to the generative AI. The analysis unit analyzes the data collected by the collection unit using generative AI. The analysis may be performed based on, for example, data analysis algorithms or analysis accuracy, but is not limited thereto. For example, the generative AI may analyze the data using a text generative AI (e.g., LLM). The analysis unit may also analyze the data using a multimodal generative AI. The analysis unit may also extract and analyze important parts of the data using generative AI. For example, the text generative AI has learned a large amount of data and has advanced natural language processing capabilities. The multimodal generative AI can handle not only text but also multiple modalities such as images and audio. The generative AI uses keyword extraction technology to pick up particularly important information in the data and perform analysis based on it. The decision unit determines the optimal operation based on the analysis result obtained by the analysis unit. The operation may be determined based on, for example, operation of home appliances or sending notifications, but is not limited thereto. For example, the decision unit may decide to play relaxing music based on the analysis result. The decision unit may also adjust lighting based on the analysis result. The decision unit may also adjust the temperature based on the analysis result. For example, the decision unit may decide to play relaxing music based on the analysis result. The decision unit may also adjust lighting based on the analysis result. The decision unit may also adjust the temperature based on the analysis result. The execution unit executes the operation determined by the decision unit. The execution may be performed based on, for example, music playback or lighting adjustment, but is not limited thereto. For example, the execution unit may play relaxing music determined by the decision unit. The execution unit may also adjust lighting as determined by the decision unit. The execution unit may also adjust the temperature as determined by the decision unit. For example, the execution unit may play relaxing music determined by the decision unit. The execution unit may also adjust lighting as determined by the decision unit. The execution unit may also adjust the temperature as determined by the decision unit. In this way, the smart home system according to the embodiment can provide a smart home that requires no operation by automatically collecting, analyzing, determining, and executing based on the user's state.

The analysis unit may include a learning unit that learns the user's behavior patterns. The learning unit, for example, learns the user's behavior patterns. The behavior patterns may include, for example, daily routines or specific events, but are not limited thereto. The learning unit may learn the user's behavior patterns and send them to the generative AI. The learning unit may also learn the user's behavior patterns and send them to the generative AI. Furthermore, the learning unit may learn the user's behavior patterns and send them to the generative AI. For example, the learning unit may learn the user's behavior patterns and send them to the generative AI. The learning unit may also learn the user's behavior patterns and send them to the generative AI. Furthermore, the learning unit may learn the user's behavior patterns and send them to the generative AI. By learning the user's behavior patterns, more appropriate operations can be provided. Some or all of the above-described processing in the learning unit may be performed using AI, for example, or may be performed without using AI. For example, the learning unit may input the user's behavior patterns to the generative AI and have the generative AI perform the learning of the behavior patterns.

The collection unit may include an encryption unit that encrypts data collected by a camera. The encryption unit, for example, encrypts data collected by a camera. Encryption may include, for example, the encryption algorithm used or the strength of encryption, but is not limited thereto. The encryption unit may encrypt data collected by a camera and send it to the generative AI. The encryption unit may also encrypt data collected by a camera and send it to the generative AI. Furthermore, the encryption unit may encrypt data collected by a camera and send it to the generative AI. For example, the encryption unit may encrypt data collected by a camera and send it to the generative AI. The encryption unit may also encrypt data collected by a camera and send it to the generative AI. Furthermore, the encryption unit may encrypt data collected by a camera and send it to the generative AI. By encrypting the collected data, privacy can be protected. Some or all of the above-described processing in the encryption unit may be performed using AI, for example, or may be performed without using AI. For example, the encryption unit may input data collected by a camera to the generative AI and have the generative AI perform the encryption of the data.

The collection unit may include a consent acquisition unit that obtains the user's consent. The consent acquisition unit, for example, obtains the user's consent. Consent may include, for example, the form of consent or the scope of consent, but is not limited thereto. The consent acquisition unit may obtain the user's consent and send it to the generative AI. The consent acquisition unit may also obtain the user's consent and send it to the generative AI. Furthermore, the consent acquisition unit may obtain the user's consent and send it to the generative AI. For example, the consent acquisition unit may obtain the user's consent and send it to the generative AI. The consent acquisition unit may also obtain the user's consent and send it to the generative AI. Furthermore, the consent acquisition unit may obtain the user's consent and send it to the generative AI. By obtaining the user's consent, transparency in data collection can be ensured. Some or all of the above-described processing in the consent acquisition unit may be performed using AI, for example, or may be performed without using AI. For example, the consent acquisition unit may input the user's consent to the generative AI and have the generative AI perform the acquisition of consent.

The execution unit may perform music playback. Music playback may include, for example, the type of music to be played or the timing of playback, but is not limited thereto. The execution unit may, for example, play relaxing music. The execution unit may also play active music. Furthermore, the execution unit may play environmental sounds. For example, the execution unit may play relaxing music. The execution unit may also play active music. Furthermore, the execution unit may play environmental sounds. By performing music playback, a comfortable environment can be provided to the user. Some or all of the above-described processing in the execution unit may be performed using AI, for example, or may be performed without using AI. For example, the execution unit may input music playback to the generative AI and have the generative AI perform the music playback.

The execution unit may perform lighting adjustment. Lighting adjustment may include, for example, brightness adjustment or color temperature change, but is not limited thereto. The execution unit may, for example, adjust the brightness of the lighting. The execution unit may also change the color temperature of the lighting. Furthermore, the execution unit may control the on/off of the lighting. For example, the execution unit may adjust the brightness of the lighting to provide a relaxing environment. The execution unit may also change the color temperature of the lighting to provide an active environment. Furthermore, the execution unit may control the on/off of the lighting to provide an appropriate lighting environment. By performing lighting adjustment, the optimal environment can be provided to the user. Some or all of the above-described processing in the execution unit may be performed using AI, for example, or may be performed without using AI. For example, the execution unit may input lighting adjustment to the generative AI and have the generative AI perform the lighting adjustment.

The collection unit may analyze the user's past behavior history and select the optimal data collection method. The collection unit may, for example, analyze the time periods when the user has relaxed in the living room in the past and concentrate data collection during those times. The collection unit may also analyze patterns of the user being active in specific rooms in the past and prioritize data collection in those rooms. Furthermore, the collection unit may analyze the user's past behavior history and perform data collection on specific days of the week or at specific times to achieve efficient data collection. For example, the collection unit may analyze the time periods when the user has relaxed in the living room in the past and concentrate data collection during those times. The collection unit may also analyze patterns of the user being active in specific rooms in the past and prioritize data collection in those rooms. Furthermore, the collection unit may analyze the user's past behavior history and perform data collection on specific days of the week or at specific times to achieve efficient data collection. By analyzing past behavior history, efficient data collection can be achieved. Some or all of the above-described processing in the collection unit may be performed using AI, for example, or may be performed without using AI. For example, the collection unit may input the user's past behavior history to the generative AI and have the generative AI perform the analysis of the behavior history.

The collection unit may perform filtering based on the user's current activity or environment at the time of data collection. For example, if the user is watching TV in the living room, the collection unit may refrain from collecting audio data and prioritize collecting video data. If the user is cooking in the kitchen, the collection unit may prioritize collecting audio data and wait for the user's instructions. Furthermore, if the user is resting in the bedroom, the collection unit may minimize data collection to protect privacy. For example, if the user is watching TV in the living room, the collection unit may refrain from collecting audio data and prioritize collecting video data. If the user is cooking in the kitchen, the collection unit may prioritize collecting audio data and wait for the user's instructions. Furthermore, if the user is resting in the bedroom, the collection unit may minimize data collection to protect privacy. By filtering data based on the user's current activity or environment, appropriate data collection can be performed. Some or all of the above-described processing in the collection unit may be performed using AI, for example, or may be performed without using AI. For example, the collection unit may input the user's current activity or environmental data to the generative AI and have the generative AI perform the data filtering.

The collection unit may prioritize collecting highly relevant data by considering the user's geographic location information at the time of data collection. For example, if the user is in the living room, the collection unit may prioritize collecting environmental data from the living room. If the user is in the kitchen, the collection unit may prioritize collecting temperature and humidity data from the kitchen. Furthermore, if the user is in the bedroom, the collection unit may prioritize collecting lighting and music data from the bedroom. For example, if the user is in the living room, the collection unit may prioritize collecting environmental data from the living room. If the user is in the kitchen, the collection unit may prioritize collecting temperature and humidity data from the kitchen. Furthermore, if the user is in the bedroom, the collection unit may prioritize collecting lighting and music data from the bedroom. By considering the user's geographic location information, highly relevant data can be prioritized for collection. Some or all of the above-described processing in the collection unit may be performed using AI, for example, or may be performed without using AI. For example, the collection unit may input the user's geographic location information to the generative AI and have the generative AI perform the collection of highly relevant data.

The collection unit may analyze the user's social media activity at the time of data collection and collect relevant data. For example, if the user posts on social media that they are relaxing, the collection unit may collect data suitable for that situation. If the user posts on social media that they are feeling stressed, the collection unit may collect data suitable for that situation. Furthermore, if the user posts on social media that they are active, the collection unit may collect data suitable for that situation. For example, if the user posts on social media that they are relaxing, the collection unit may collect data suitable for that situation. If the user posts on social media that they are feeling stressed, the collection unit may collect data suitable for that situation. Furthermore, if the user posts on social media that they are active, the collection unit may collect data suitable for that situation. By analyzing social media activity, relevant data can be efficiently collected. Some or all of the above-described processing in the collection unit may be performed using AI, for example, or may be performed without using AI. For example, the collection unit may input the user's social media activity data to the generative AI and have the generative AI perform the collection of relevant data.

The analysis unit may adjust the level of detail of analysis based on the importance of the data during analysis. For example, the analysis unit may perform detailed analysis and generate specific suggestions for highly important data. For less important data, the analysis unit may perform simplified analysis and provide only a summary. Furthermore, for data of moderate importance, the analysis unit may perform analysis at an appropriate level of detail and provide balanced information. For example, the analysis unit may perform detailed analysis and generate specific suggestions for highly important data. For less important data, the analysis unit may perform simplified analysis and provide only a summary. Furthermore, for data of moderate importance, the analysis unit may perform analysis at an appropriate level of detail and provide balanced information. By adjusting the level of detail of analysis based on the importance of the data, efficient analysis can be performed. Some or all of the above-described processing in the analysis unit may be performed using AI, for example, or may be performed without using AI. For example, the analysis unit may input the importance of the data to the generative AI and have the generative AI perform the adjustment of the analysis detail level.

The analysis unit may apply different analysis algorithms according to the category of data during analysis. For example, for music data, the analysis unit may analyze based on the genre or tempo of the music. For lighting data, the analysis unit may analyze based on the color temperature or brightness of the lighting. Furthermore, for environmental data, the analysis unit may analyze based on temperature or humidity. For example, for music data, the analysis unit may analyze based on the genre or tempo of the music. For lighting data, the analysis unit may analyze based on the color temperature or brightness of the lighting. Furthermore, for environmental data, the analysis unit may analyze based on temperature or humidity. By applying different analysis algorithms according to the category of data, more appropriate analysis can be performed. Some or all of the above-described processing in the analysis unit may be performed using AI, for example, or may be performed without using AI. For example, the analysis unit may input the data category to the generative AI and have the generative AI perform the application of the analysis algorithm.

The analysis unit may determine the priority of analysis based on the timing of data collection during analysis. For example, the analysis unit may prioritize the analysis of the latest data to enable real-time response. The analysis unit may also refer to past data and perform analysis to understand long-term trends. Furthermore, the analysis unit may prioritize the analysis of data collected at specific times and respond appropriately to those times. For example, the analysis unit may prioritize the analysis of the latest data to enable real-time response. The analysis unit may also refer to past data and perform analysis to understand long-term trends. Furthermore, the analysis unit may prioritize the analysis of data collected at specific times and respond appropriately to those times. By determining the priority of analysis based on the timing of data collection, real-time response becomes possible. Some or all of the above-described processing in the analysis unit may be performed using AI, for example, or may be performed without using AI. For example, the analysis unit may input the timing of data collection to the generative AI and have the generative AI perform the determination of analysis priority.

The analysis unit may adjust the order of analysis based on the relevance of the data during analysis. For example, the analysis unit may prioritize the analysis of highly relevant data to enable prompt response. The analysis unit may also postpone the analysis of less relevant data and prioritize the analysis of important data. Furthermore, the analysis unit may dynamically adjust the order of analysis according to the relevance of the data to perform efficient analysis. For example, the analysis unit may prioritize the analysis of highly relevant data to enable prompt response. The analysis unit may also postpone the analysis of less relevant data and prioritize the analysis of important data. Furthermore, the analysis unit may dynamically adjust the order of analysis according to the relevance of the data to perform efficient analysis. By adjusting the order of analysis based on the relevance of the data, efficient analysis can be performed. Some or all of the above-described processing in the analysis unit may be performed using AI, for example, or may be performed without using AI. For example, the analysis unit may input the relevance of the data to the generative AI and have the generative AI perform the adjustment of the analysis order.

The decision unit may improve the accuracy of decisions by considering the interrelationship of analysis results when making operation decisions. For example, the decision unit may link music playback and lighting adjustment to provide an environment optimal for the user's emotions. The decision unit may also link environmental sounds and temperature adjustment to maximize user comfort. Furthermore, the decision unit may link lighting color temperature and music genre to provide an environment tailored to the user's mood. For example, the decision unit may link music playback and lighting adjustment to provide an environment optimal for the user's emotions. The decision unit may also link environmental sounds and temperature adjustment to maximize user comfort. Furthermore, the decision unit may link lighting color temperature and music genre to provide an environment tailored to the user's mood. By considering the interrelationship of analysis results, the accuracy of decisions can be improved. Some or all of the above-described processing in the decision unit may be performed using AI, for example, or may be performed without using AI. For example, the decision unit may input the interrelationship of analysis results to the generative AI and have the generative AI perform the improvement of decision accuracy.

The decision unit may determine appropriate operations by considering user attribute information when making operation decisions. For example, the decision unit may select an appropriate music genre according to the user's age. The decision unit may also adjust the preferred lighting color temperature according to the user's gender. Furthermore, the decision unit may play appropriate environmental sounds according to the user's health condition. For example, the decision unit may select an appropriate music genre according to the user's age. The decision unit may also adjust the preferred lighting color temperature according to the user's gender. Furthermore, the decision unit may play appropriate environmental sounds according to the user's health condition. By considering user attribute information, optimal operations can be provided. Some or all of the above-described processing in the decision unit may be performed using AI, for example, or may be performed without using AI. For example, the decision unit may input user attribute information to the generative AI and have the generative AI perform the operation decision.

The decision unit may determine operations by considering the geographic distribution of data when making operation decisions. For example, if the user is in the living room, the decision unit may determine operations suitable for the living room. If the user is in the kitchen, the decision unit may determine operations suitable for the kitchen. Furthermore, if the user is in the bedroom, the decision unit may determine operations suitable for the bedroom. For example, if the user is in the living room, the decision unit may determine operations suitable for the living room. If the user is in the kitchen, the decision unit may determine operations suitable for the kitchen. Furthermore, if the user is in the bedroom, the decision unit may determine operations suitable for the bedroom. By considering the geographic distribution of data, optimal operations can be provided. Some or all of the above-described processing in the decision unit may be performed using AI, for example, or may be performed without using AI. For example, the decision unit may input the geographic distribution of data to the generative AI and have the generative AI perform the operation decision.

The decision unit may improve the accuracy of decisions by referring to related literature when making operation decisions. For example, the decision unit may refer to the latest research papers to select the optimal music genre. The decision unit may also refer to literature on lighting adjustment to determine the optimal color temperature. Furthermore, the decision unit may refer to literature on the effects of environmental sounds to select the optimal environmental sound. For example, the decision unit may refer to the latest research papers to select the optimal music genre. The decision unit may also refer to literature on lighting adjustment to determine the optimal color temperature. Furthermore, the decision unit may refer to literature on the effects of environmental sounds to select the optimal environmental sound. By referring to related literature, the accuracy of decisions can be improved. Some or all of the above-described processing in the decision unit may be performed using AI, for example, or may be performed without using AI. For example, the decision unit may input related literature to the generative AI and have the generative AI perform the improvement of decision accuracy.

The execution unit may improve the accuracy of execution by considering the interrelationship of operations during execution. For example, the execution unit may link music playback and lighting adjustment to provide an environment optimal for the user's emotions. The execution unit may also link environmental sounds and temperature adjustment to maximize user comfort. Furthermore, the execution unit may link lighting color temperature and music genre to provide an environment tailored to the user's mood. For example, the execution unit may link music playback and lighting adjustment to provide an environment optimal for the user's emotions. The execution unit may also link environmental sounds and temperature adjustment to maximize user comfort. Furthermore, the execution unit may link lighting color temperature and music genre to provide an environment tailored to the user's mood. By considering the interrelationship of operations, the accuracy of execution can be improved. Some or all of the above-described processing in the execution unit may be performed using AI, for example, or may be performed without using AI. For example, the execution unit may input the interrelationship of operations to the generative AI and have the generative AI perform the improvement of execution accuracy.

The execution unit may customize operations by considering user attribute information during execution. For example, the execution unit may select an appropriate music genre according to the user's age. The execution unit may also adjust the preferred lighting color temperature according to the user's gender. Furthermore, the execution unit may play appropriate environmental sounds according to the user's health condition. For example, the execution unit may select an appropriate music genre according to the user's age. The execution unit may also adjust the preferred lighting color temperature according to the user's gender. Furthermore, the execution unit may play appropriate environmental sounds according to the user's health condition. By considering user attribute information, more appropriate operations can be provided. Some or all of the above-described processing in the execution unit may be performed using AI, for example, or may be performed without using AI. For example, the execution unit may input user attribute information to the generative AI and have the generative AI perform the customization of operations.

The execution unit may execute operations by considering the geographic distribution of data during execution. For example, if the user is in the living room, the execution unit may execute operations suitable for the living room. If the user is in the kitchen, the execution unit may execute operations suitable for the kitchen. Furthermore, if the user is in the bedroom, the execution unit may execute operations suitable for the bedroom. For example, if the user is in the living room, the execution unit may execute operations suitable for the living room. If the user is in the kitchen, the execution unit may execute operations suitable for the kitchen. Furthermore, if the user is in the bedroom, the execution unit may execute operations suitable for the bedroom. By considering the geographic distribution of data, optimal operations can be provided. Some or all of the above-described processing in the execution unit may be performed using AI, for example, or may be performed without using AI. For example, the execution unit may input the geographic distribution of data to the generative AI and have the generative AI perform the execution of operations.

The execution unit may improve the accuracy of execution by referring to related literature during execution. For example, the execution unit may refer to the latest research papers to select the optimal music genre. The execution unit may also refer to literature on lighting adjustment to determine the optimal color temperature. Furthermore, the execution unit may refer to literature on the effects of environmental sounds to select the optimal environmental sound. For example, the execution unit may refer to the latest research papers to select the optimal music genre. The execution unit may also refer to literature on lighting adjustment to determine the optimal color temperature. Furthermore, the execution unit may refer to literature on the effects of environmental sounds to select the optimal environmental sound. By referring to related literature, the accuracy of execution can be improved. Some or all of the above-described processing in the execution unit may be performed using AI, for example, or may be performed without using AI. For example, the execution unit may input related literature to the generative AI and have the generative AI perform the improvement of execution accuracy.

The learning unit may optimize the learning algorithm by referring to past learning data during learning. For example, the learning unit may select the optimal learning algorithm based on past learning data. The learning unit may also analyze past learning data and adjust the parameters of the learning algorithm. Furthermore, the learning unit may refer to past learning data to improve the accuracy of the learning algorithm. For example, the learning unit may select the optimal learning algorithm based on past learning data. The learning unit may also analyze past learning data and adjust the parameters of the learning algorithm. Furthermore, the learning unit may refer to past learning data to improve the accuracy of the learning algorithm. By referring to past learning data, the accuracy of the learning algorithm can be improved. Some or all of the above-described processing in the learning unit may be performed using AI, for example, or may be performed without using AI. For example, the learning unit may input past learning data to the generative AI and have the generative AI perform the optimization of the learning algorithm.

The learning unit may weight learning data based on the timing of data collection during learning. For example, the learning unit may assign a higher weight to the latest data to enable real-time response. The learning unit may also assign a lower weight to past data and perform learning to understand long-term trends. Furthermore, the learning unit may assign appropriate weights to data collected at specific times and respond appropriately to those times. For example, the learning unit may assign a higher weight to the latest data to enable real-time response. The learning unit may also assign a lower weight to past data and perform learning to understand long-term trends. Furthermore, the learning unit may assign appropriate weights to data collected at specific times and respond appropriately to those times. By weighting learning data based on the timing of data collection, real-time response becomes possible. Some or all of the above-described processing in the learning unit may be performed using AI, for example, or may be performed without using AI. For example, the learning unit may input the timing of data collection to the generative AI and have the generative AI perform the weighting of learning data.

The encryption unit may adjust the level of detail of encryption based on the importance of the data during encryption. For example, the encryption unit may perform detailed encryption for highly important data to ensure data security. The encryption unit may also perform simplified encryption for less important data to improve processing speed. Furthermore, the encryption unit may perform encryption at an appropriate level of detail for data of moderate importance to achieve balanced data protection. For example, the encryption unit may perform detailed encryption for highly important data to ensure data security. The encryption unit may also perform simplified encryption for less important data to improve processing speed. Furthermore, the encryption unit may perform encryption at an appropriate level of detail for data of moderate importance to achieve balanced data protection. By adjusting the level of detail of encryption based on the importance of the data, efficient data protection can be performed. Some or all of the above-described processing in the encryption unit may be performed using AI, for example, or may be performed without using AI. For example, the encryption unit may input the importance of the data to the generative AI and have the generative AI perform the adjustment of the encryption detail level.

The encryption unit may adjust the order of encryption based on the timing of data collection during encryption. For example, the encryption unit may prioritize encrypting the latest data to enable real-time response. The encryption unit may also postpone the encryption of past data and prioritize the encryption of important data. Furthermore, the encryption unit may prioritize encrypting data collected at specific times and respond appropriately to those times. For example, the encryption unit may prioritize encrypting the latest data to enable real-time response. The encryption unit may also postpone the encryption of past data and prioritize the encryption of important data. Furthermore, the encryption unit may prioritize encrypting data collected at specific times and respond appropriately to those times. By adjusting the order of encryption based on the timing of data collection, real-time response becomes possible. Some or all of the above-described processing in the encryption unit may be performed using AI, for example, or may be performed without using AI. For example, the encryption unit may input the timing of data collection to the generative AI and have the generative AI perform the adjustment of the encryption order.

The consent acquisition unit may select the optimal consent acquisition method by referring to the user's past consent history during consent acquisition. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. By referring to the user's past consent history, the optimal consent acquisition method can be selected. Some or all of the above-described processing in the consent acquisition unit may be performed using AI, for example, or may be performed without using AI. For example, the consent acquisition unit may input the user's past consent history to the generative AI and have the generative AI perform the selection of the consent acquisition method.

The consent acquisition unit may select an appropriate consent acquisition method by considering the user's device information during consent acquisition. For example, if the user is using a smartphone, the consent acquisition unit provides a consent acquisition method tailored to the screen size. If the user is using a tablet, the consent acquisition unit may provide a consent acquisition method optimized for a large screen. Furthermore, if the user is using a smartwatch, the consent acquisition unit may provide a concise and highly visible consent acquisition method. For example, if the user is using a smartphone, the consent acquisition unit provides a consent acquisition method tailored to the screen size. If the user is using a tablet, the consent acquisition unit may provide a consent acquisition method optimized for a large screen. Furthermore, if the user is using a smartwatch, the consent acquisition unit may provide a concise and highly visible consent acquisition method. By considering the user's device information, the optimal consent acquisition method can be selected. Some or all of the above-described processing in the consent acquisition unit may be performed using AI, for example, or may be performed without using AI. For example, the consent acquisition unit may input the user's device information to the generative AI and have the generative AI perform the selection of the consent acquisition method.

The system according to the embodiment is not limited to the above-described examples, and various modifications are possible, for example, as follows.

The collection unit may include a health data collection unit that collects the user's health data. The health data collection unit may, for example, collect the user's vital signs such as heart rate, blood pressure, and body temperature. The health data collection unit may also collect the user's activity level and sleep patterns. Furthermore, the health data collection unit may collect the user's dietary content and calorie intake. By using the collected health data, the user's health status can be understood and appropriate responses can be taken. Some or all of the above-described processing in the health data collection unit may be performed using AI, for example, or may be performed without using AI. For example, the health data collection unit may input the collected health data to the generative AI and have the generative AI perform the analysis of the health status.

The analysis unit may include a hobby and preference learning unit that learns the user's hobbies and preferences. The hobby and preference learning unit may, for example, learn the music genres and types of movies the user likes. The hobby and preference learning unit may also learn the foods and drinks the user likes. Furthermore, the hobby and preference learning unit may learn the travel destinations and activities the user likes. By learning the user's hobbies and preferences, more personalized services can be provided. Some or all of the above-described processing in the hobby and preference learning unit may be performed using AI, for example, or may be performed without using AI. For example, the hobby and preference learning unit may input the user's hobby and preference data to the generative AI and have the generative AI perform the learning of hobbies and preferences.

The encryption unit may apply different encryption algorithms according to the type of data. For example, advanced encryption algorithms may be applied to personal information data, and lightweight encryption algorithms may be applied to general environmental data. The encryption unit may also apply voice-specific encryption algorithms to audio data and video-specific encryption algorithms to video data. Furthermore, the encryption unit may apply text-specific encryption algorithms to text data. By performing optimal encryption according to the type of data, efficient data protection can be achieved. Some or all of the above-described processing in the encryption unit may be performed using AI, for example, or may be performed without using AI. For example, the encryption unit may input the type of data to the generative AI and have the generative AI perform the application of the encryption algorithm.

The consent acquisition unit may select the optimal consent acquisition method by referring to the user's past consent history when obtaining consent. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. By referring to the user's past consent history, the optimal consent acquisition method can be selected. Some or all of the above-described processing in the consent acquisition unit may be performed using AI, for example, or may be performed without using AI. For example, the consent acquisition unit may input the user's past consent history to the generative AI and have the generative AI perform the selection of the consent acquisition method.

The execution unit may execute operations by considering the user's health status. For example, if the user's heart rate is high, relaxing music may be played. If the user's body temperature is high, the operation to lower the room temperature may be executed. Furthermore, appropriate lighting or music may be provided based on the user's sleep pattern. By providing optimal operations according to the user's health status, a more suitable environment can be provided. Some or all of the above-described processing in the execution unit may be performed using AI, for example, or may be performed without using AI. For example, the execution unit may input the user's health data to the generative AI and have the generative AI perform the execution of operations.

The following is a brief description of the processing flow of Example 1 of the Embodiment.

Step 1: The collection unit collects the user's state. The user's state includes actions, facial expressions, and voice. The collection unit may collect the user's actions using a camera, collect the user's voice using a microphone, and collect the user's facial expressions using a sensor. The collected data is sent to the generative AI.

Step 2: The analysis unit analyzes the data collected by the collection unit using the generative AI. The analysis is performed based on data analysis algorithms and analysis accuracy. The generative AI analyzes the data using a text generative AI (e.g., LLM) or a multimodal generative AI, and extracts and analyzes important parts.

Step 3: The decision unit determines the optimal operation based on the analysis result obtained by the analysis unit. The operation is determined based on, for example, operation of home appliances or sending notifications. Examples include playing relaxing music, adjusting lighting, and adjusting temperature.

Step 4: The execution unit executes the operation determined by the decision unit. The execution is performed based on, for example, music playback, lighting adjustment, and temperature adjustment. Examples include playing relaxing music, adjusting lighting, and adjusting temperature.

### Example 2 of the Embodiment

The smart home system according to the embodiment of the present invention is a smart home system that does not require instructions via a smart speaker equipped with a camera and generative AI. This smart home system collects the user's state using a camera installed in the smart speaker, and the generative AI analyzes the data to recognize the user's behavior. Based on the analysis result, the generative AI determines the optimal operation and autonomously performs actions such as playing music. As a result, the user can enjoy a comfortable environment without operating a smartphone or speaking to the speaker. Furthermore, the system also has a function to learn the user's behavior patterns and provide the optimal environment according to the time of day and situation. In addition, to protect privacy with the camera, mechanisms for data encryption and obtaining user consent are also included. For example, the user's state is collected by a camera installed in the smart speaker. For example, the camera captures the user relaxing in the living room. This data is sent to the generative AI. Next, the generative AI analyzes the collected data and recognizes the user's behavior. For example, if it determines that the user is relaxing, the generative AI selects music suitable for that situation. Based on the analysis result, the generative AI determines the optimal operation. For example, it decides to play relaxing music for a relaxing user. The determined operation is executed. For example, the smart speaker plays music. In this way, the user can enjoy a comfortable environment without any operation. Furthermore, the generative AI learns the user's behavior patterns and provides the optimal environment according to the time of day and situation. For example, it plays relaxing music at night and awakening music in the morning. In addition, to protect privacy with the camera, mechanisms for data encryption and obtaining user consent are also included. For example, the collected data is encrypted and analyzed only after obtaining the user's consent. In this way, the smart home system can provide a smart home that requires no operation by automatically collecting, analyzing, determining, and executing based on the user's state.

The smart home system according to the embodiment comprises a collection unit, an analysis unit, a decision unit, and an execution unit. The collection unit collects the state of the user. The user's state may include, for example, actions, facial expressions, and voice, but is not limited thereto. The collection unit may collect the user's actions using a camera, for example. The collection unit may also collect the user's voice using a microphone. Furthermore, the collection unit may collect the user's facial expressions using a sensor. For example, the collection unit may collect the user's actions in real time using a camera and send them to the generative AI. The collection unit may also collect the user's voice using a microphone and send it to the generative AI. Furthermore, the collection unit may collect the user's facial expressions using a sensor and send them to the generative AI. The analysis unit analyzes the data collected by the collection unit using generative AI. The analysis may be performed based on, for example, data analysis algorithms or analysis accuracy, but is not limited thereto. For example, the generative AI may analyze the data using a text generative AI (e.g., LLM). The analysis unit may also analyze the data using a multimodal generative AI. The analysis unit may also extract and analyze important parts of the data using generative AI. For example, the text generative AI has learned a large amount of data and has advanced natural language processing capabilities. The multimodal generative AI can handle not only text but also multiple modalities such as images and audio. The generative AI uses keyword extraction technology to pick up particularly important information in the data and perform analysis based on it. The decision unit determines the optimal operation based on the analysis result obtained by the analysis unit. The operation may be determined based on, for example, operation of home appliances or sending notifications, but is not limited thereto. For example, the decision unit may decide to play relaxing music based on the analysis result. The decision unit may also adjust lighting based on the analysis result. The decision unit may also adjust the temperature based on the analysis result. For example, the decision unit may decide to play relaxing music based on the analysis result. The decision unit may also adjust lighting based on the analysis result. The decision unit may also adjust the temperature based on the analysis result. The execution unit executes the operation determined by the decision unit. The execution may be performed based on, for example, music playback or lighting adjustment, but is not limited thereto. For example, the execution unit may play relaxing music determined by the decision unit. The execution unit may also adjust lighting as determined by the decision unit. The execution unit may also adjust the temperature as determined by the decision unit. For example, the execution unit may play relaxing music determined by the decision unit. The execution unit may also adjust lighting as determined by the decision unit. The execution unit may also adjust the temperature as determined by the decision unit. In this way, the smart home system according to the embodiment can provide a smart home that requires no operation by automatically collecting, analyzing, determining, and executing based on the user's state.

The analysis unit may include a learning unit that learns the user's behavior patterns. The learning unit, for example, learns the user's behavior patterns. The behavior patterns may include, for example, daily routines or specific events, but are not limited thereto. The learning unit may learn the user's behavior patterns and send them to the generative AI. The learning unit may also learn the user's behavior patterns and send them to the generative AI. Furthermore, the learning unit may learn the user's behavior patterns and send them to the generative AI. For example, the learning unit may learn the user's behavior patterns and send them to the generative AI. The learning unit may also learn the user's behavior patterns and send them to the generative AI. Furthermore, the learning unit may learn the user's behavior patterns and send them to the generative AI. By learning the user's behavior patterns, more appropriate operations can be provided. Some or all of the above-described processing in the learning unit may be performed using AI, for example, or may be performed without using AI. For example, the learning unit may input the user's behavior patterns to the generative AI and have the generative AI perform the learning of the behavior patterns.

The collection unit may include an encryption unit that encrypts data collected by a camera. The encryption unit, for example, encrypts data collected by a camera. Encryption may include, for example, the encryption algorithm used or the strength of encryption, but is not limited thereto. The encryption unit may encrypt data collected by a camera and send it to the generative AI. The encryption unit may also encrypt data collected by a camera and send it to the generative AI. Furthermore, the encryption unit may encrypt data collected by a camera and send it to the generative AI. For example, the encryption unit may encrypt data collected by a camera and send it to the generative AI. The encryption unit may also encrypt data collected by a camera and send it to the generative AI. Furthermore, the encryption unit may encrypt data collected by a camera and send it to the generative AI. By encrypting the collected data, privacy can be protected. Some or all of the above-described processing in the encryption unit may be performed using AI, for example, or may be performed without using AI. For example, the encryption unit may input data collected by a camera to the generative AI and have the generative AI perform the encryption of the data.

The collection unit may include a consent acquisition unit that obtains the user's consent. The consent acquisition unit, for example, obtains the user's consent. Consent may include, for example, the form of consent or the scope of consent, but is not limited thereto. The consent acquisition unit may obtain the user's consent and send it to the generative AI. The consent acquisition unit may also obtain the user's consent and send it to the generative AI. Furthermore, the consent acquisition unit may obtain the user's consent and send it to the generative AI. For example, the consent acquisition unit may obtain the user's consent and send it to the generative AI. The consent acquisition unit may also obtain the user's consent and send it to the generative AI. Furthermore, the consent acquisition unit may obtain the user's consent and send it to the generative AI. By obtaining the user's consent, transparency in data collection can be ensured. Some or all of the above-described processing in the consent acquisition unit may be performed using AI, for example, or may be performed without using AI. For example, the consent acquisition unit may input the user's consent to the generative AI and have the generative AI perform the acquisition of consent.

The execution unit may perform music playback. Music playback may include, for example, the type of music to be played or the timing of playback, but is not limited thereto. The execution unit may, for example, play relaxing music. The execution unit may also play active music. Furthermore, the execution unit may play environmental sounds. For example, the execution unit may play relaxing music. The execution unit may also play active music. Furthermore, the execution unit may play environmental sounds. By performing music playback, a comfortable environment can be provided to the user. Some or all of the above-described processing in the execution unit may be performed using AI, for example, or may be performed without using AI. For example, the execution unit may input music playback to the generative AI and have the generative AI perform the music playback.

The execution unit may perform lighting adjustment. Lighting adjustment may include, for example, brightness adjustment or color temperature change, but is not limited thereto. The execution unit may, for example, adjust the brightness of the lighting. The execution unit may also change the color temperature of the lighting. Furthermore, the execution unit may control the on/off of the lighting. For example, the execution unit may adjust the brightness of the lighting to provide a relaxing environment. The execution unit may also change the color temperature of the lighting to provide an active environment. Furthermore, the execution unit may control the on/off of the lighting to provide an appropriate lighting environment. By performing lighting adjustment, the optimal environment can be provided to the user. Some or all of the above-described processing in the execution unit may be performed using AI, for example, or may be performed without using AI. For example, the execution unit may input lighting adjustment to the generative AI and have the generative AI perform the lighting adjustment.

The collection unit may estimate the user's emotion and adjust the timing of data collection based on the estimated user emotion. For example, if it is estimated that the user is relaxing, the frequency of data collection is reduced to respect the user's privacy. If it is estimated that the user is feeling stressed, the frequency of data collection is increased to enable prompt and appropriate response. Furthermore, if it is estimated that the user is active, the timing of data collection is shortened to enable real-time response. For example, if it is estimated that the user is relaxing, the frequency of data collection is reduced to respect the user's privacy. If it is estimated that the user is feeling stressed, the frequency of data collection is increased to enable prompt and appropriate response. Furthermore, if it is estimated that the user is active, the timing of data collection is shortened to enable real-time response. By adjusting the timing of data collection according to the user's emotion, appropriate data collection can be performed while respecting privacy. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the collection unit may be performed using AI, for example, or may be performed without using AI. For example, the collection unit may input the user's emotion data to the generative AI and have the generative AI perform the emotion estimation.

The collection unit may analyze the user's past behavior history and select the optimal data collection method. The collection unit may, for example, analyze the time periods when the user has relaxed in the living room in the past and concentrate data collection during those times. The collection unit may also analyze patterns of the user being active in specific rooms in the past and prioritize data collection in those rooms. Furthermore, the collection unit may analyze the user's past behavior history and perform data collection on specific days of the week or at specific times to achieve efficient data collection. For example, the collection unit may analyze the time periods when the user has relaxed in the living room in the past and concentrate data collection during those times. The collection unit may also analyze patterns of the user being active in specific rooms in the past and prioritize data collection in those rooms. Furthermore, the collection unit may analyze the user's past behavior history and perform data collection on specific days of the week or at specific times to achieve efficient data collection. By analyzing past behavior history, efficient data collection can be achieved. Some or all of the above-described processing in the collection unit may be performed using AI, for example, or may be performed without using AI. For example, the collection unit may input the user's past behavior history to the generative AI and have the generative AI perform the analysis of the behavior history.

The collection unit may perform filtering based on the user's current activity or environment at the time of data collection. For example, if the user is watching TV in the living room, the collection unit may refrain from collecting audio data and prioritize collecting video data. If the user is cooking in the kitchen, the collection unit may prioritize collecting audio data and wait for the user's instructions. Furthermore, if the user is resting in the bedroom, the collection unit may minimize data collection to protect privacy. For example, if the user is watching TV in the living room, the collection unit may refrain from collecting audio data and prioritize collecting video data. If the user is cooking in the kitchen, the collection unit may prioritize collecting audio data and wait for the user's instructions. Furthermore, if the user is resting in the bedroom, the collection unit may minimize data collection to protect privacy. By filtering data based on the user's current activity or environment, appropriate data collection can be performed. Some or all of the above-described processing in the collection unit may be performed using AI, for example, or may be performed without using AI. For example, the collection unit may input the user's current activity or environmental data to the generative AI and have the generative AI perform the data filtering.

The collection unit may estimate the user's emotion and determine the priority of data to be collected based on the estimated user emotion. For example, if it is estimated that the user is relaxing, the collection unit prioritizes collecting music and lighting data. If it is estimated that the user is feeling stressed, the collection unit may prioritize collecting environmental sound and temperature data. Furthermore, if it is estimated that the user is active, the collection unit may prioritize collecting activity and heart rate data. For example, if it is estimated that the user is relaxing, the collection unit prioritizes collecting music and lighting data. If it is estimated that the user is feeling stressed, the collection unit may prioritize collecting environmental sound and temperature data. Furthermore, if it is estimated that the user is active, the collection unit may prioritize collecting activity and heart rate data. By determining the priority of data according to the user's emotion, more appropriate data collection can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the collection unit may be performed using AI, for example, or may be performed without using AI. For example, the collection unit may input the user's emotion data to the generative AI and have the generative AI perform the emotion estimation.

The collection unit may prioritize collecting highly relevant data by considering the user's geographic location information at the time of data collection. For example, if the user is in the living room, the collection unit may prioritize collecting environmental data from the living room. If the user is in the kitchen, the collection unit may prioritize collecting temperature and humidity data from the kitchen. Furthermore, if the user is in the bedroom, the collection unit may prioritize collecting lighting and music data from the bedroom. For example, if the user is in the living room, the collection unit may prioritize collecting environmental data from the living room. If the user is in the kitchen, the collection unit may prioritize collecting temperature and humidity data from the kitchen. Furthermore, if the user is in the bedroom, the collection unit may prioritize collecting lighting and music data from the bedroom. By considering the user's geographic location information, highly relevant data can be prioritized for collection. Some or all of the above-described processing in the collection unit may be performed using AI, for example, or may be performed without using AI. For example, the collection unit may input the user's geographic location information to the generative AI and have the generative AI perform the collection of highly relevant data.

The collection unit may analyze the user's social media activity at the time of data collection and collect relevant data. For example, if the user posts on social media that they are relaxing, the collection unit may collect data suitable for that situation. If the user posts on social media that they are feeling stressed, the collection unit may collect data suitable for that situation. Furthermore, if the user posts on social media that they are active, the collection unit may collect data suitable for that situation. For example, if the user posts on social media that they are relaxing, the collection unit may collect data suitable for that situation. If the user posts on social media that they are feeling stressed, the collection unit may collect data suitable for that situation. Furthermore, if the user posts on social media that they are active, the collection unit may collect data suitable for that situation. By analyzing social media activity, relevant data can be efficiently collected. Some or all of the above-described processing in the collection unit may be performed using AI, for example, or may be performed without using AI. For example, the collection unit may input the user's social media activity data to the generative AI and have the generative AI perform the collection of relevant data.

The analysis unit may estimate the user's emotion and adjust the method of presenting analysis results based on the estimated user emotion. For example, if it is estimated that the user is relaxing, the analysis result is displayed visually with calm colors. If it is estimated that the user is feeling stressed, the analysis result may be displayed in a simple and highly visible format. Furthermore, if it is estimated that the user is active, the analysis result may be displayed as dynamic graphs or animations. For example, if it is estimated that the user is relaxing, the analysis result is displayed visually with calm colors. If it is estimated that the user is feeling stressed, the analysis result may be displayed in a simple and highly visible format. Furthermore, if it is estimated that the user is active, the analysis result may be displayed as dynamic graphs or animations. By adjusting the method of presenting analysis results according to the user's emotion, more appropriate analysis results can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the analysis unit may be performed using AI, for example, or may be performed without using AI. For example, the analysis unit may input the user's emotion data to the generative AI and have the generative AI perform the emotion estimation.

The analysis unit may adjust the level of detail of analysis based on the importance of the data during analysis. For example, the analysis unit may perform detailed analysis and generate specific suggestions for highly important data. For less important data, the analysis unit may perform simplified analysis and provide only a summary. Furthermore, for data of moderate importance, the analysis unit may perform analysis at an appropriate level of detail and provide balanced information. For example, the analysis unit may perform detailed analysis and generate specific suggestions for highly important data. For less important data, the analysis unit may perform simplified analysis and provide only a summary. Furthermore, for data of moderate importance, the analysis unit may perform analysis at an appropriate level of detail and provide balanced information. By adjusting the level of detail of analysis based on the importance of the data, efficient analysis can be performed. Some or all of the above-described processing in the analysis unit may be performed using AI, for example, or may be performed without using AI. For example, the analysis unit may input the importance of the data to the generative AI and have the generative AI perform the adjustment of the analysis detail level.

The analysis unit may apply different analysis algorithms according to the category of data during analysis. For example, for music data, the analysis unit may analyze based on the genre or tempo of the music. For lighting data, the analysis unit may analyze based on the color temperature or brightness of the lighting. Furthermore, for environmental data, the analysis unit may analyze based on temperature or humidity. For example, for music data, the analysis unit may analyze based on the genre or tempo of the music. For lighting data, the analysis unit may analyze based on the color temperature or brightness of the lighting. Furthermore, for environmental data, the analysis unit may analyze based on temperature or humidity. By applying different analysis algorithms according to the category of data, more appropriate analysis can be performed. Some or all of the above-described processing in the analysis unit may be performed using AI, for example, or may be performed without using AI. For example, the analysis unit may input the data category to the generative AI and have the generative AI perform the application of the analysis algorithm.

The analysis unit may estimate the user's emotion and adjust the length of analysis based on the estimated user emotion. For example, if it is estimated that the user is relaxing, detailed analysis results are provided. If it is estimated that the user is feeling stressed, concise analysis results may be provided. Furthermore, if it is estimated that the user is active, analysis results focusing on key points may be provided. For example, if it is estimated that the user is relaxing, detailed analysis results are provided. If it is estimated that the user is feeling stressed, concise analysis results may be provided. Furthermore, if it is estimated that the user is active, analysis results focusing on key points may be provided. By adjusting the length of analysis according to the user's emotion, more appropriate analysis results can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the analysis unit may be performed using AI, for example, or may be performed without using AI. For example, the analysis unit may input the user's emotion data to the generative AI and have the generative AI perform the emotion estimation.

The analysis unit may determine the priority of analysis based on the timing of data collection during analysis. For example, the analysis unit may prioritize the analysis of the latest data to enable real-time response. The analysis unit may also refer to past data and perform analysis to understand long-term trends. Furthermore, the analysis unit may prioritize the analysis of data collected at specific times and respond appropriately to those times. For example, the analysis unit may prioritize the analysis of the latest data to enable real-time response. The analysis unit may also refer to past data and perform analysis to understand long-term trends. Furthermore, the analysis unit may prioritize the analysis of data collected at specific times and respond appropriately to those times. By determining the priority of analysis based on the timing of data collection, real-time response becomes possible. Some or all of the above-described processing in the analysis unit may be performed using AI, for example, or may be performed without using AI. For example, the analysis unit may input the timing of data collection to the generative AI and have the generative AI perform the determination of analysis priority.

The analysis unit may adjust the order of analysis based on the relevance of the data during analysis. For example, the analysis unit may prioritize the analysis of highly relevant data to enable prompt response. The analysis unit may also postpone the analysis of less relevant data and prioritize the analysis of important data. Furthermore, the analysis unit may dynamically adjust the order of analysis according to the relevance of the data to perform efficient analysis. For example, the analysis unit may prioritize the analysis of highly relevant data to enable prompt response. The analysis unit may also postpone the analysis of less relevant data and prioritize the analysis of important data. Furthermore, the analysis unit may dynamically adjust the order of analysis according to the relevance of the data to perform efficient analysis. By adjusting the order of analysis based on the relevance of the data, efficient analysis can be performed. Some or all of the above-described processing in the analysis unit may be performed using AI, for example, or may be performed without using AI. For example, the analysis unit may input the relevance of the data to the generative AI and have the generative AI perform the adjustment of the analysis order.

The decision unit may estimate the user's emotion and adjust the criteria for operation decision based on the estimated user emotion. For example, if it is estimated that the user is relaxing, relaxing music is played. If it is estimated that the user is feeling stressed, environmental sounds to reduce stress may be played. Furthermore, if it is estimated that the user is active, up-tempo music to support activity may be played. For example, if it is estimated that the user is relaxing, relaxing music is played. If it is estimated that the user is feeling stressed, environmental sounds to reduce stress may be played. Furthermore, if it is estimated that the user is active, up-tempo music to support activity may be played. By adjusting the criteria for operation decision according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the decision unit may be performed using AI, for example, or may be performed without using AI. For example, the decision unit may input the user's emotion data to the generative AI and have the generative AI perform the emotion estimation.

The decision unit may improve the accuracy of decisions by considering the interrelationship of analysis results when making operation decisions. For example, the decision unit may link music playback and lighting adjustment to provide an environment optimal for the user's emotions. The decision unit may also link environmental sounds and temperature adjustment to maximize user comfort. Furthermore, the decision unit may link lighting color temperature and music genre to provide an environment tailored to the user's mood. For example, the decision unit may link music playback and lighting adjustment to provide an environment optimal for the user's emotions. The decision unit may also link environmental sounds and temperature adjustment to maximize user comfort. Furthermore, the decision unit may link lighting color temperature and music genre to provide an environment tailored to the user's mood. By considering the interrelationship of analysis results, the accuracy of decisions can be improved. Some or all of the above-described processing in the decision unit may be performed using AI, for example, or may be performed without using AI. For example, the decision unit may input the interrelationship of analysis results to the generative AI and have the generative AI perform the improvement of decision accuracy.

The decision unit may determine appropriate operations by considering user attribute information when making operation decisions. For example, the decision unit may select an appropriate music genre according to the user's age. The decision unit may also adjust the preferred lighting color temperature according to the user's gender. Furthermore, the decision unit may play appropriate environmental sounds according to the user's health condition. For example, the decision unit may select an appropriate music genre according to the user's age. The decision unit may also adjust the preferred lighting color temperature according to the user's gender. Furthermore, the decision unit may play appropriate environmental sounds according to the user's health condition. By considering user attribute information, optimal operations can be provided. Some or all of the above-described processing in the decision unit may be performed using AI, for example, or may be performed without using AI. For example, the decision unit may input user attribute information to the generative AI and have the generative AI perform the operation decision.

The decision unit may estimate the user's emotion and adjust the order in which operation decision results are displayed based on the estimated user emotion. For example, if it is estimated that the user is relaxing, operations that promote relaxation are displayed with the highest priority. If it is estimated that the user is feeling stressed, operations to reduce stress may be displayed with the highest priority. Furthermore, if it is estimated that the user is active, operations to support activity may be displayed with the highest priority. For example, if it is estimated that the user is relaxing, operations that promote relaxation are displayed with the highest priority. If it is estimated that the user is feeling stressed, operations to reduce stress may be displayed with the highest priority. Furthermore, if it is estimated that the user is active, operations to support activity may be displayed with the highest priority. By adjusting the order in which operation decision results are displayed according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the decision unit may be performed using AI, for example, or may be performed without using AI. For example, the decision unit may input the user's emotion data to the generative AI and have the generative AI perform the emotion estimation.

The decision unit may determine operations by considering the geographic distribution of data when making operation decisions. For example, if the user is in the living room, the decision unit may determine operations suitable for the living room. If the user is in the kitchen, the decision unit may determine operations suitable for the kitchen. Furthermore, if the user is in the bedroom, the decision unit may determine operations suitable for the bedroom. For example, if the user is in the living room, the decision unit may determine operations suitable for the living room. If the user is in the kitchen, the decision unit may determine operations suitable for the kitchen. Furthermore, if the user is in the bedroom, the decision unit may determine operations suitable for the bedroom. By considering the geographic distribution of data, optimal operations can be provided. Some or all of the above-described processing in the decision unit may be performed using AI, for example, or may be performed without using AI. For example, the decision unit may input the geographic distribution of data to the generative AI and have the generative AI perform the operation decision.

The decision unit may improve the accuracy of decisions by referring to related literature when making operation decisions. For example, the decision unit may refer to the latest research papers to select the optimal music genre. The decision unit may also refer to literature on lighting adjustment to determine the optimal color temperature. Furthermore, the decision unit may refer to literature on the effects of environmental sounds to select the optimal environmental sound. For example, the decision unit may refer to the latest research papers to select the optimal music genre. The decision unit may also refer to literature on lighting adjustment to determine the optimal color temperature. Furthermore, the decision unit may refer to literature on the effects of environmental sounds to select the optimal environmental sound. By referring to related literature, the accuracy of decisions can be improved. Some or all of the above-described processing in the decision unit may be performed using AI, for example, or may be performed without using AI. For example, the decision unit may input related literature to the generative AI and have the generative AI perform the improvement of decision accuracy.

The execution unit may estimate the user's emotion and determine the priority of operations to be executed based on the estimated user emotion. For example, if it is estimated that the user is relaxing, relaxing music is played with the highest priority. If it is estimated that the user is feeling stressed, environmental sounds to reduce stress may be played with the highest priority. Furthermore, if it is estimated that the user is active, music to support activity may be played with the highest priority. For example, if it is estimated that the user is relaxing, relaxing music is played with the highest priority. If it is estimated that the user is feeling stressed, environmental sounds to reduce stress may be played with the highest priority. Furthermore, if it is estimated that the user is active, music to support activity may be played with the highest priority. By determining the priority of operations according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the execution unit may be performed using AI, for example, or may be performed without using AI. For example, the execution unit may input the user's emotion data to the generative AI and have the generative AI perform the emotion estimation.

The execution unit may improve the accuracy of execution by considering the interrelationship of operations during execution. For example, the execution unit may link music playback and lighting adjustment to provide an environment optimal for the user's emotions. The execution unit may also link environmental sounds and temperature adjustment to maximize user comfort. Furthermore, the execution unit may link lighting color temperature and music genre to provide an environment tailored to the user's mood. For example, the execution unit may link music playback and lighting adjustment to provide an environment optimal for the user's emotions. The execution unit may also link environmental sounds and temperature adjustment to maximize user comfort. Furthermore, the execution unit may link lighting color temperature and music genre to provide an environment tailored to the user's mood. By considering the interrelationship of operations, the accuracy of execution can be improved. Some or all of the above-described processing in the execution unit may be performed using AI, for example, or may be performed without using AI. For example, the execution unit may input the interrelationship of operations to the generative AI and have the generative AI perform the improvement of execution accuracy.

The execution unit may customize operations by considering user attribute information during execution. For example, the execution unit may select an appropriate music genre according to the user's age. The execution unit may also adjust the preferred lighting color temperature according to the user's gender. Furthermore, the execution unit may play appropriate environmental sounds according to the user's health condition. For example, the execution unit may select an appropriate music genre according to the user's age. The execution unit may also adjust the preferred lighting color temperature according to the user's gender. Furthermore, the execution unit may play appropriate environmental sounds according to the user's health condition. By considering user attribute information, more appropriate operations can be provided. Some or all of the above-described processing in the execution unit may be performed using AI, for example, or may be performed without using AI. For example, the execution unit may input user attribute information to the generative AI and have the generative AI perform the customization of operations.

The execution unit may estimate the user's emotion and adjust the method of displaying operations to be executed based on the estimated user emotion. For example, if it is estimated that the user is relaxing, operations are displayed in calm colors. If it is estimated that the user is feeling stressed, operations may be displayed in a simple and highly visible format. Furthermore, if it is estimated that the user is active, operations may be displayed as dynamic graphs or animations. For example, if it is estimated that the user is relaxing, operations are displayed in calm colors. If it is estimated that the user is feeling stressed, operations may be displayed in a simple and highly visible format. Furthermore, if it is estimated that the user is active, operations may be displayed as dynamic graphs or animations. By adjusting the method of displaying operations according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the execution unit may be performed using AI, for example, or may be performed without using AI. For example, the execution unit may input the user's emotion data to the generative AI and have the generative AI perform the emotion estimation.

The execution unit may execute operations by considering the geographic distribution of data during execution. For example, if the user is in the living room, the execution unit may execute operations suitable for the living room. If the user is in the kitchen, the execution unit may execute operations suitable for the kitchen. Furthermore, if the user is in the bedroom, the execution unit may execute operations suitable for the bedroom. For example, if the user is in the living room, the execution unit may execute operations suitable for the living room. If the user is in the kitchen, the execution unit may execute operations suitable for the kitchen. Furthermore, if the user is in the bedroom, the execution unit may execute operations suitable for the bedroom. By considering the geographic distribution of data, optimal operations can be provided. Some or all of the above-described processing in the execution unit may be performed using AI, for example, or may be performed without using AI. For example, the execution unit may input the geographic distribution of data to the generative AI and have the generative AI perform the execution of operations.

The execution unit may improve the accuracy of execution by referring to related literature during execution. For example, the execution unit may refer to the latest research papers to select the optimal music genre. The execution unit may also refer to literature on lighting adjustment to determine the optimal color temperature. Furthermore, the execution unit may refer to literature on the effects of environmental sounds to select the optimal environmental sound. For example, the execution unit may refer to the latest research papers to select the optimal music genre. The execution unit may also refer to literature on lighting adjustment to determine the optimal color temperature. Furthermore, the execution unit may refer to literature on the effects of environmental sounds to select the optimal environmental sound. By referring to related literature, the accuracy of execution can be improved. Some or all of the above-described processing in the execution unit may be performed using AI, for example, or may be performed without using AI. For example, the execution unit may input related literature to the generative AI and have the generative AI perform the improvement of execution accuracy.

The learning unit may estimate the user's emotion and select learning data based on the estimated user emotion. For example, if it is estimated that the user is relaxing, learning data suitable for that situation is selected. If it is estimated that the user is feeling stressed, learning data useful for stress reduction may be selected. Furthermore, if it is estimated that the user is active, learning data to support activity may be selected. For example, if it is estimated that the user is relaxing, learning data suitable for that situation is selected. If it is estimated that the user is feeling stressed, learning data useful for stress reduction may be selected. Furthermore, if it is estimated that the user is active, learning data to support activity may be selected. By selecting learning data according to the user's emotion, more appropriate learning can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the learning unit may be performed using AI, for example, or may be performed without using AI. For example, the learning unit may input the user's emotion data to the generative AI and have the generative AI perform the emotion estimation.

The learning unit may optimize the learning algorithm by referring to past learning data during learning. For example, the learning unit may select the optimal learning algorithm based on past learning data. The learning unit may also analyze past learning data and adjust the parameters of the learning algorithm. Furthermore, the learning unit may refer to past learning data to improve the accuracy of the learning algorithm. For example, the learning unit may select the optimal learning algorithm based on past learning data. The learning unit may also analyze past learning data and adjust the parameters of the learning algorithm. Furthermore, the learning unit may refer to past learning data to improve the accuracy of the learning algorithm. By referring to past learning data, the accuracy of the learning algorithm can be improved. Some or all of the above-described processing in the learning unit may be performed using AI, for example, or may be performed without using AI. For example, the learning unit may input past learning data to the generative AI and have the generative AI perform the optimization of the learning algorithm.

The learning unit may estimate the user's emotion and adjust the frequency of learning based on the estimated user emotion. For example, if it is estimated that the user is relaxing, the frequency of learning is reduced to respect the user's privacy. If it is estimated that the user is feeling stressed, the frequency of learning is increased to enable prompt and appropriate response. Furthermore, if it is estimated that the user is active, the frequency of learning is shortened to enable real-time response. For example, if it is estimated that the user is relaxing, the frequency of learning is reduced to respect the user's privacy. If it is estimated that the user is feeling stressed, the frequency of learning is increased to enable prompt and appropriate response. Furthermore, if it is estimated that the user is active, the frequency of learning is shortened to enable real-time response. By adjusting the frequency of learning according to the user's emotion, more appropriate learning can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the learning unit may be performed using AI, for example, or may be performed without using AI. For example, the learning unit may input the user's emotion data to the generative AI and have the generative AI perform the emotion estimation.

The learning unit may weight learning data based on the timing of data collection during learning. For example, the learning unit may assign a higher weight to the latest data to enable real-time response. The learning unit may also assign a lower weight to past data and perform learning to understand long-term trends. Furthermore, the learning unit may assign appropriate weights to data collected at specific times and respond appropriately to those times. For example, the learning unit may assign a higher weight to the latest data to enable real-time response. The learning unit may also assign a lower weight to past data and perform learning to understand long-term trends. Furthermore, the learning unit may assign appropriate weights to data collected at specific times and respond appropriately to those times. By weighting learning data based on the timing of data collection, real-time response becomes possible. Some or all of the above-described processing in the learning unit may be performed using AI, for example, or may be performed without using AI. For example, the learning unit may input the timing of data collection to the generative AI and have the generative AI perform the weighting of learning data.

The encryption unit may estimate the user's emotion and adjust the strength of encryption based on the estimated user emotion. For example, if it is estimated that the user is relaxing, standard encryption strength is used. If it is estimated that the user is feeling stressed, high encryption strength may be used to ensure data security. Furthermore, if it is estimated that the user is active, moderate encryption strength may be used to maintain data processing speed. For example, if it is estimated that the user is relaxing, standard encryption strength is used. If it is estimated that the user is feeling stressed, high encryption strength may be used to ensure data security. Furthermore, if it is estimated that the user is active, moderate encryption strength may be used to maintain data processing speed. By adjusting the strength of encryption according to the user's emotion, data security can be ensured. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the encryption unit may be performed using AI, for example, or may be performed without using AI. For example, the encryption unit may input the user's emotion data to the generative AI and have the generative AI perform the emotion estimation.

The encryption unit may adjust the level of detail of encryption based on the importance of the data during encryption. For example, the encryption unit may perform detailed encryption for highly important data to ensure data security. The encryption unit may also perform simplified encryption for less important data to improve processing speed. Furthermore, the encryption unit may perform encryption at an appropriate level of detail for data of moderate importance to achieve balanced data protection. For example, the encryption unit may perform detailed encryption for highly important data to ensure data security. The encryption unit may also perform simplified encryption for less important data to improve processing speed. Furthermore, the encryption unit may perform encryption at an appropriate level of detail for data of moderate importance to achieve balanced data protection. By adjusting the level of detail of encryption based on the importance of the data, efficient data protection can be performed. Some or all of the above-described processing in the encryption unit may be performed using AI, for example, or may be performed without using AI. For example, the encryption unit may input the importance of the data to the generative AI and have the generative AI perform the adjustment of the encryption detail level.

The encryption unit may estimate the user's emotion and determine the priority of encryption based on the estimated user emotion. For example, if it is estimated that the user is relaxing, standard encryption is prioritized. If it is estimated that the user is feeling stressed, high encryption strength may be prioritized. Furthermore, if it is estimated that the user is active, moderate encryption strength may be prioritized. For example, if it is estimated that the user is relaxing, standard encryption is prioritized. If it is estimated that the user is feeling stressed, high encryption strength may be prioritized. Furthermore, if it is estimated that the user is active, moderate encryption strength may be prioritized. By determining the priority of encryption according to the user's emotion, efficient data protection can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the encryption unit may be performed using AI, for example, or may be performed without using AI. For example, the encryption unit may input the user's emotion data to the generative AI and have the generative AI perform the emotion estimation.

The encryption unit may adjust the order of encryption based on the timing of data collection during encryption. For example, the encryption unit may prioritize encrypting the latest data to enable real-time response. The encryption unit may also postpone the encryption of past data and prioritize the encryption of important data. Furthermore, the encryption unit may prioritize encrypting data collected at specific times and respond appropriately to those times. For example, the encryption unit may prioritize encrypting the latest data to enable real-time response. The encryption unit may also postpone the encryption of past data and prioritize the encryption of important data. Furthermore, the encryption unit may prioritize encrypting data collected at specific times and respond appropriately to those times. By adjusting the order of encryption based on the timing of data collection, real-time response becomes possible. Some or all of the above-described processing in the encryption unit may be performed using AI, for example, or may be performed without using AI. For example, the encryption unit may input the timing of data collection to the generative AI and have the generative AI perform the adjustment of the encryption order.

The consent acquisition unit may estimate the user's emotion and adjust the method of consent acquisition based on the estimated user emotion. For example, if it is estimated that the user is relaxing, a consent acquisition method including detailed explanations is provided. If it is estimated that the user is feeling stressed, a concise and easy-to-understand consent acquisition method may be provided. Furthermore, if it is estimated that the user is active, a method that enables quick consent acquisition may be provided. For example, if it is estimated that the user is relaxing, a consent acquisition method including detailed explanations is provided. If it is estimated that the user is feeling stressed, a concise and easy-to-understand consent acquisition method may be provided. Furthermore, if it is estimated that the user is active, a method that enables quick consent acquisition may be provided. By adjusting the method of consent acquisition according to the user's emotion, more appropriate consent acquisition can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the consent acquisition unit may be performed using AI, for example, or may be performed without using AI. For example, the consent acquisition unit may input the user's emotion data to the generative AI and have the generative AI perform the emotion estimation.

The consent acquisition unit may select the optimal consent acquisition method by referring to the user's past consent history during consent acquisition. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. By referring to the user's past consent history, the optimal consent acquisition method can be selected. Some or all of the above-described processing in the consent acquisition unit may be performed using AI, for example, or may be performed without using AI. For example, the consent acquisition unit may input the user's past consent history to the generative AI and have the generative AI perform the selection of the consent acquisition method.

The consent acquisition unit may estimate the user's emotion and determine the priority of consent acquisition based on the estimated user emotion. For example, if it is estimated that the user is relaxing, consent acquisition with detailed explanations is prioritized. If it is estimated that the user is feeling stressed, concise and easy-to-understand consent acquisition may be prioritized. Furthermore, if it is estimated that the user is active, a method that enables quick consent acquisition may be prioritized. For example, if it is estimated that the user is relaxing, consent acquisition with detailed explanations is prioritized. If it is estimated that the user is feeling stressed, concise and easy-to-understand consent acquisition may be prioritized. Furthermore, if it is estimated that the user is active, a method that enables quick consent acquisition may be prioritized. By determining the priority of consent acquisition according to the user's emotion, more appropriate consent acquisition can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the consent acquisition unit may be performed using AI, for example, or may be performed without using AI. For example, the consent acquisition unit may input the user's emotion data to the generative AI and have the generative AI perform the emotion estimation.

The consent acquisition unit may select an appropriate consent acquisition method by considering the user's device information during consent acquisition. For example, if the user is using a smartphone, the consent acquisition unit provides a consent acquisition method tailored to the screen size. If the user is using a tablet, the consent acquisition unit may provide a consent acquisition method optimized for a large screen. Furthermore, if the user is using a smartwatch, the consent acquisition unit may provide a concise and highly visible consent acquisition method. For example, if the user is using a smartphone, the consent acquisition unit provides a consent acquisition method tailored to the screen size. If the user is using a tablet, the consent acquisition unit may provide a consent acquisition method optimized for a large screen. Furthermore, if the user is using a smartwatch, the consent acquisition unit may provide a concise and highly visible consent acquisition method. By considering the user's device information, the optimal consent acquisition method can be selected. Some or all of the above-described processing in the consent acquisition unit may be performed using AI, for example, or may be performed without using AI. For example, the consent acquisition unit may input the user's device information to the generative AI and have the generative AI perform the selection of the consent acquisition method.

### ==Hardware Guarantee 1-1==

Each of the multiple elements including the above-described collection unit, analysis unit, decision unit, and execution unit is realized by at least one of, for example, the smart device 14 and the data processing apparatus 12. For example, the collection unit collects the user's state using the camera 42 or microphone 38B of the smart device 14 and sends it to the data processing apparatus 12 via the control unit 46A. The analysis unit is realized, for example, by the specific processing unit 290 of the data processing apparatus 12 and analyzes the collected data. The decision unit is realized, for example, by the specific processing unit 290 of the data processing apparatus 12 and determines the optimal operation based on the analysis result. The execution unit is realized, for example, by the control unit 46A of the smart device 14 and executes the determined operation.

### ==Hardware Guarantee 1-2==

Each of the multiple elements including the above-described collection unit, analysis unit, decision unit, and execution unit is realized by at least one of, for example, the smart glasses 214 and the data processing apparatus 12. For example, the collection unit collects the user's state using the camera 42 or microphone 238 of the smart glasses 214 and sends it to the data processing apparatus 12 via the control unit 46A. The analysis unit is realized, for example, by the specific processing unit 290 of the data processing apparatus 12 and analyzes the collected data. The decision unit is realized, for example, by the specific processing unit 290 of the data processing apparatus 12 and determines the optimal operation based on the analysis result. The execution unit is realized, for example, by the control unit 46A of the smart glasses 214 and executes the determined operation.

### ==Hardware Guarantee 1-3==

Each of the multiple elements including the above-described collection unit, analysis unit, decision unit, and execution unit is realized by at least one of, for example, the headset-type terminal 314 and the data processing apparatus 12. For example, the collection unit collects the user's state using the camera 42 or microphone 238 of the headset-type terminal 314 and sends it to the data processing apparatus 12 via the control unit 46A. The analysis unit is realized, for example, by the specific processing unit 290 of the data processing apparatus 12 and analyzes the collected data. The decision unit is realized, for example, by the specific processing unit 290 of the data processing apparatus 12 and determines the optimal operation based on the analysis result. The execution unit is realized, for example, by the control unit 46A of the headset-type terminal 314 and executes the determined operation.

### ==Hardware Guarantee 1-4==

Each of the multiple elements including the above-described collection unit, analysis unit, decision unit, and execution unit is realized by at least one of, for example, the robot 414 and the data processing apparatus 12. For example, the collection unit collects the user's state using the camera 42 or microphone 238 of the robot 414 and sends it to the data processing apparatus 12 via the control unit 46A. The analysis unit is realized, for example, by the specific processing unit 290 of the data processing apparatus 12 and analyzes the collected data. The decision unit is realized, for example, by the specific processing unit 290 of the data processing apparatus 12 and determines the optimal operation based on the analysis result. The execution unit is realized, for example, by the control unit 46A of the robot 414 and executes the determined operation.

The system according to the embodiment is not limited to the above-described examples, and various modifications are possible, for example, as follows.

The collection unit may include a health data collection unit that collects the user's health data. The health data collection unit may, for example, collect the user's vital signs such as heart rate, blood pressure, and body temperature. The health data collection unit may also collect the user's activity level and sleep patterns. Furthermore, the health data collection unit may collect the user's dietary content and calorie intake. By using the collected health data, the user's health status can be understood and appropriate responses can be taken. Some or all of the above-described processing in the health data collection unit may be performed using AI, for example, or may be performed without using AI. For example, the health data collection unit may input the collected health data to the generative AI and have the generative AI perform the analysis of the health status.

The analysis unit may include a hobby and preference learning unit that learns the user's hobbies and preferences. The hobby and preference learning unit may, for example, learn the music genres and types of movies the user likes. The hobby and preference learning unit may also learn the foods and drinks the user likes. Furthermore, the hobby and preference learning unit may learn the travel destinations and activities the user likes. By learning the user's hobbies and preferences, more personalized services can be provided. Some or all of the above-described processing in the hobby and preference learning unit may be performed using AI, for example, or may be performed without using AI. For example, the hobby and preference learning unit may input the user's hobby and preference data to the generative AI and have the generative AI perform the learning of hobbies and preferences.

The encryption unit may apply different encryption algorithms according to the type of data. For example, advanced encryption algorithms may be applied to personal information data, and lightweight encryption algorithms may be applied to general environmental data. The encryption unit may also apply voice-specific encryption algorithms to audio data and video-specific encryption algorithms to video data. Furthermore, the encryption unit may apply text-specific encryption algorithms to text data. By performing optimal encryption according to the type of data, efficient data protection can be achieved. Some or all of the above-described processing in the encryption unit may be performed using AI, for example, or may be performed without using AI. For example, the encryption unit may input the type of data to the generative AI and have the generative AI perform the application of the encryption algorithm.

The consent acquisition unit may select the optimal consent acquisition method by referring to the user's past consent history when obtaining consent. For example, the consent acquisition unit may select the optimal consent acquisition method based on the method the user has previously agreed to. The consent acquisition unit may also analyze the user's past consent history and optimize the consent acquisition procedure. Furthermore, the consent acquisition unit may refer to the user's past consent history and adjust the frequency of consent acquisition. By referring to the user's past consent history, the optimal consent acquisition method can be selected. Some or all of the above-described processing in the consent acquisition unit may be performed using AI, for example, or may be performed without using AI. For example, the consent acquisition unit may input the user's past consent history to the generative AI and have the generative AI perform the selection of the consent acquisition method.

The execution unit may execute operations by considering the user's health status. For example, if the user's heart rate is high, relaxing music may be played. If the user's body temperature is high, the operation to lower the room temperature may be executed. Furthermore, appropriate lighting or music may be provided based on the user's sleep pattern. By providing optimal operations according to the user's health status, a more suitable environment can be provided. Some or all of the above-described processing in the execution unit may be performed using AI, for example, or may be performed without using AI. For example, the execution unit may input the user's health data to the generative AI and have the generative AI perform the execution of operations.

The collection unit may estimate the user's emotion and adjust the timing of data collection based on the estimated user emotion. For example, if it is estimated that the user is relaxing, the frequency of data collection is reduced to respect the user's privacy. If it is estimated that the user is feeling stressed, the frequency of data collection is increased to enable prompt and appropriate response. Furthermore, if it is estimated that the user is active, the timing of data collection is shortened to enable real-time response. By adjusting the timing of data collection according to the user's emotion, appropriate data collection can be performed while respecting privacy. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the collection unit may be performed using AI, for example, or may be performed without using AI. For example, the collection unit may input the user's emotion data to the generative AI and have the generative AI perform the emotion estimation.

The analysis unit may estimate the user's emotion and adjust the method of presenting analysis results based on the estimated user emotion. For example, if it is estimated that the user is relaxing, the analysis result is displayed visually with calm colors. If it is estimated that the user is feeling stressed, the analysis result may be displayed in a simple and highly visible format. Furthermore, if it is estimated that the user is active, the analysis result may be displayed as dynamic graphs or animations. By adjusting the method of presenting analysis results according to the user's emotion, more appropriate analysis results can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the analysis unit may be performed using AI, for example, or may be performed without using AI. For example, the analysis unit may input the user's emotion data to the generative AI and have the generative AI perform the emotion estimation.

The decision unit may estimate the user's emotion and adjust the criteria for operation decision based on the estimated user emotion. For example, if it is estimated that the user is relaxing, relaxing music is played. If it is estimated that the user is feeling stressed, environmental sounds to reduce stress may be played. Furthermore, if it is estimated that the user is active, up-tempo music to support activity may be played. By adjusting the criteria for operation decision according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the decision unit may be performed using AI, for example, or may be performed without using AI. For example, the decision unit may input the user's emotion data to the generative AI and have the generative AI perform the emotion estimation.

The execution unit may estimate the user's emotion and determine the priority of operations to be executed based on the estimated user emotion. For example, if it is estimated that the user is relaxing, relaxing music is played with the highest priority. If it is estimated that the user is feeling stressed, environmental sounds to reduce stress may be played with the highest priority. Furthermore, if it is estimated that the user is active, music to support activity may be played with the highest priority. By determining the priority of operations according to the user's emotion, more appropriate operations can be provided. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the execution unit may be performed using AI, for example, or may be performed without using AI. For example, the execution unit may input the user's emotion data to the generative AI and have the generative AI perform the emotion estimation.

The learning unit may estimate the user's emotion and select learning data based on the estimated user emotion. For example, if it is estimated that the user is relaxing, learning data suitable for that situation is selected. If it is estimated that the user is feeling stressed, learning data useful for stress reduction may be selected. Furthermore, if it is estimated that the user is active, learning data to support activity may be selected. By selecting learning data according to the user's emotion, more appropriate learning can be performed. Emotion estimation is realized using, for example, an emotion engine or a generative AI with emotion estimation functionality. The generative AI may be a text generative AI (e.g., LLM) or a multimodal generative AI, but is not limited thereto. Some or all of the above-described processing in the learning unit may be performed using AI, for example, or may be performed without using AI. For example, the learning unit may input the user's emotion data to the generative AI and have the generative AI perform the emotion estimation.

The following is a brief description of the processing flow of Example 2 of the Embodiment.

Step 1: The collection unit collects the user's state. The user's state includes actions, facial expressions, and voice. The collection unit may collect the user's actions using a camera, collect the user's voice using a microphone, and collect the user's facial expressions using a sensor. The collected data is sent to the generative AI.

Step 2: The analysis unit analyzes the data collected by the collection unit using the generative AI. The analysis is performed based on data analysis algorithms and analysis accuracy. The generative AI analyzes the data using a text generative AI (e.g., LLM) or a multimodal generative AI, and extracts and analyzes important parts.

Step 3: The decision unit determines the optimal operation based on the analysis result obtained by the analysis unit. The operation is determined based on, for example, operation of home appliances or sending notifications. Examples include playing relaxing music, adjusting lighting, and adjusting temperature.

Step 4: The execution unit executes the operation determined by the decision unit. The execution is performed based on, for example, music playback, lighting adjustment, and temperature adjustment. Examples include playing relaxing music, adjusting lighting, and adjusting temperature.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the device or control unit is not limited to the above-described example, and various modifications are possible.

### Second Embodiment

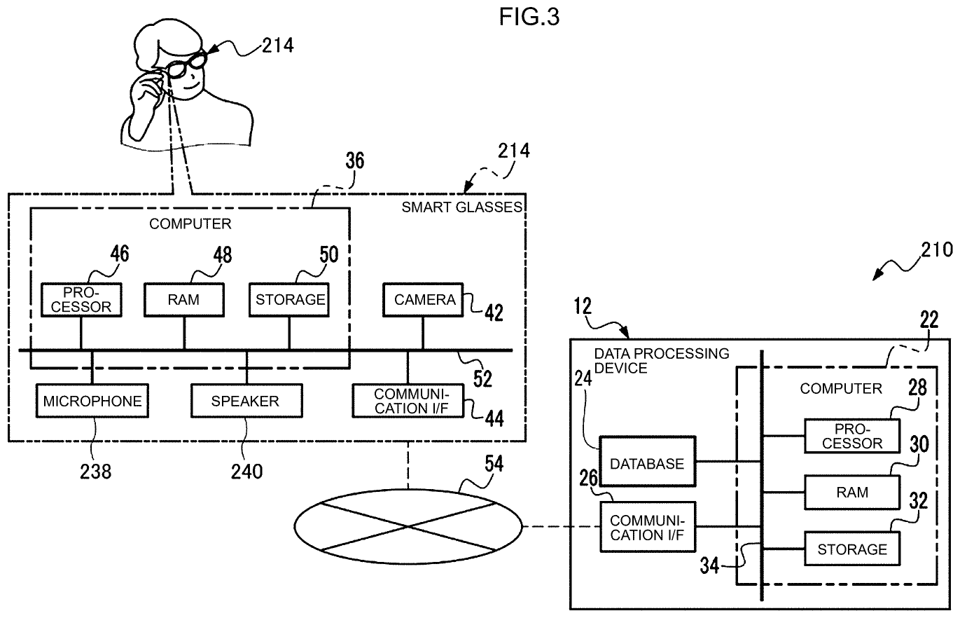

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

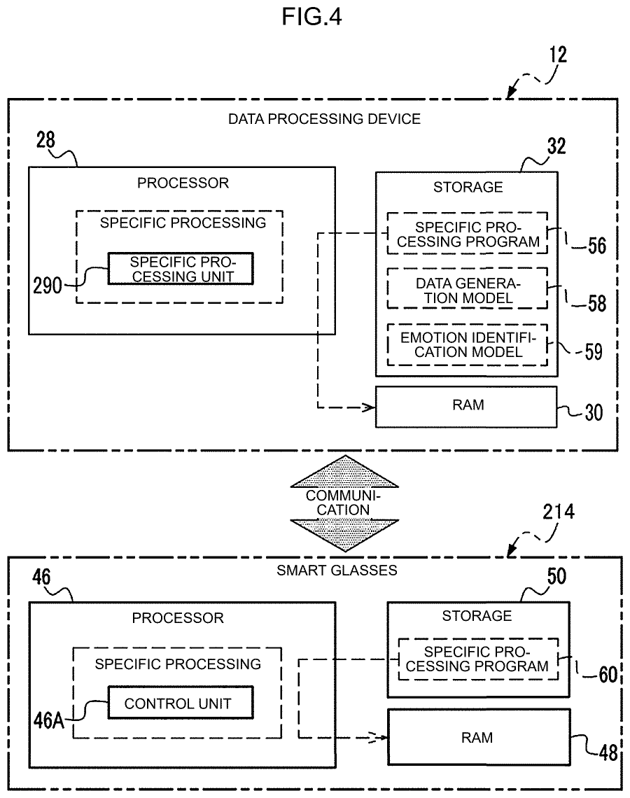

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the device or control unit is not limited to the above-described example, and various modifications are possible.

### Third Embodiment

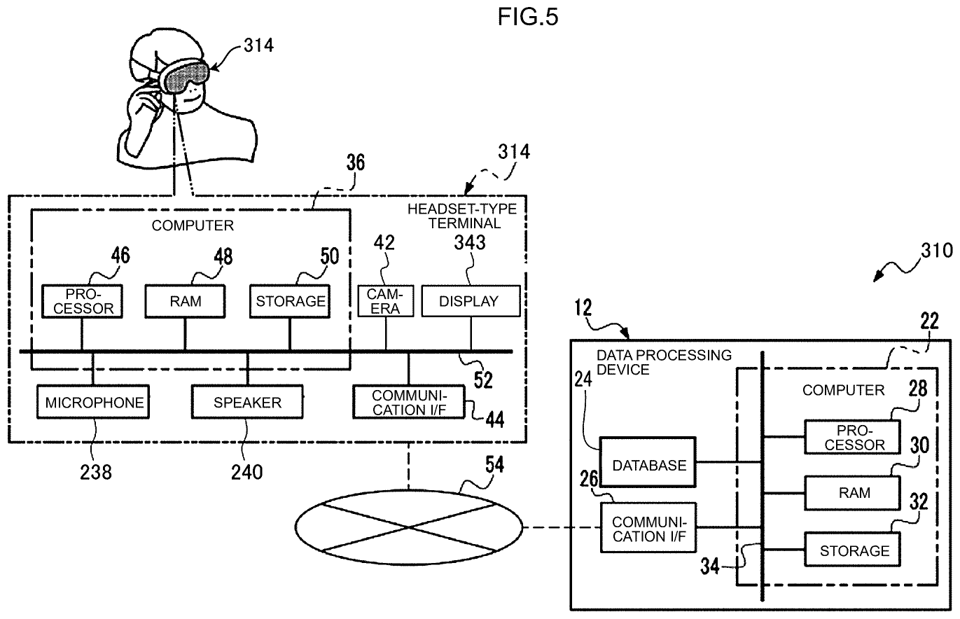

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

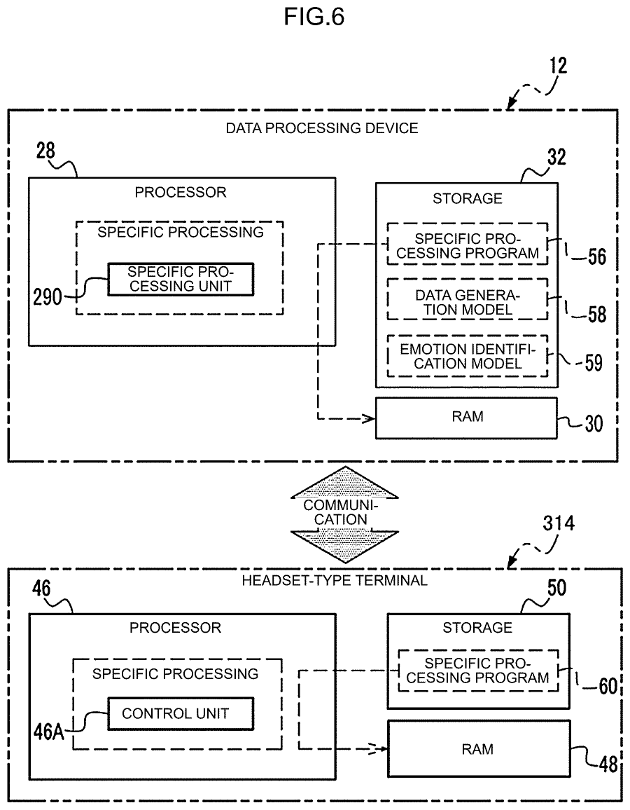

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the device or control unit is not limited to the above-described example, and various modifications are possible.

### Fourth Embodiment

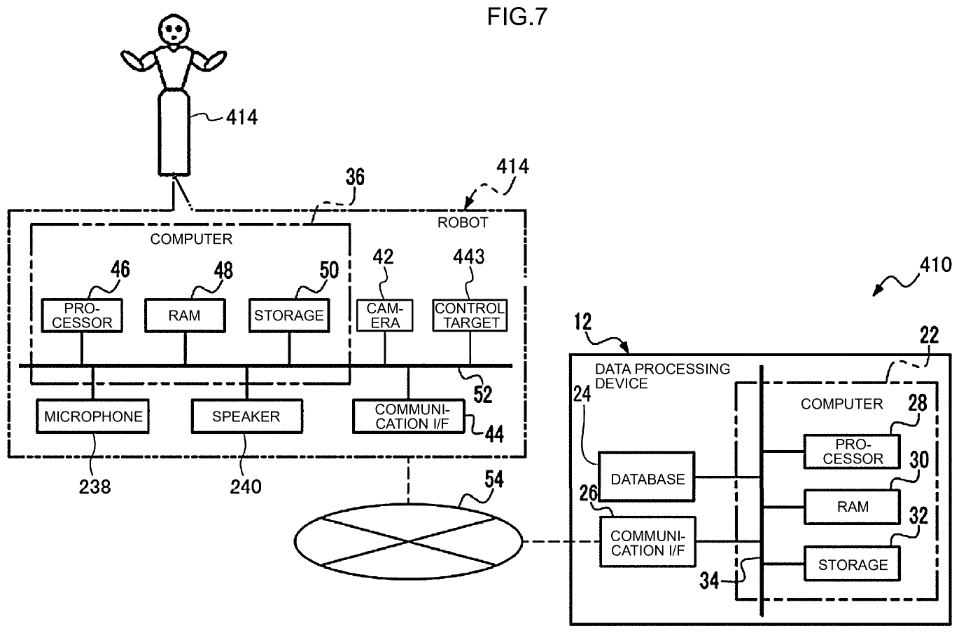

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

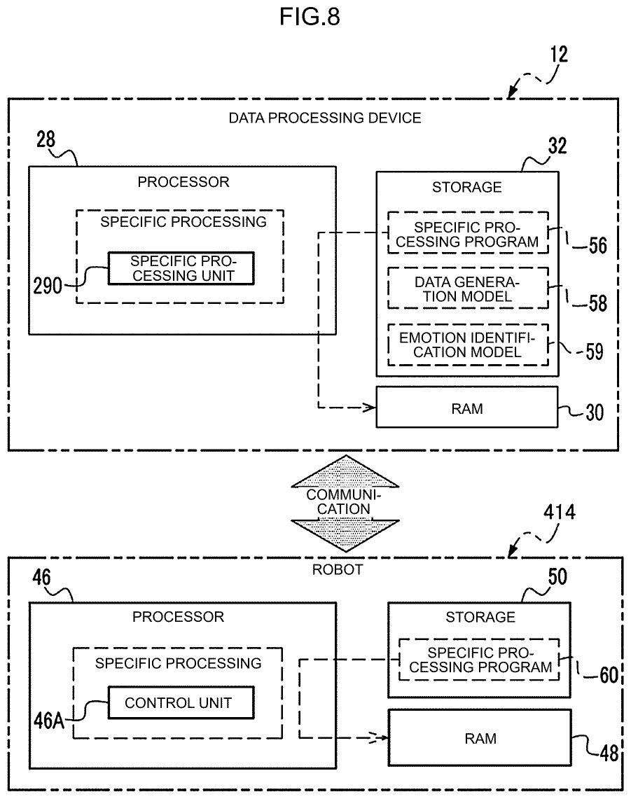

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the device or control unit is not limited to the above-described example, and various modifications are possible.

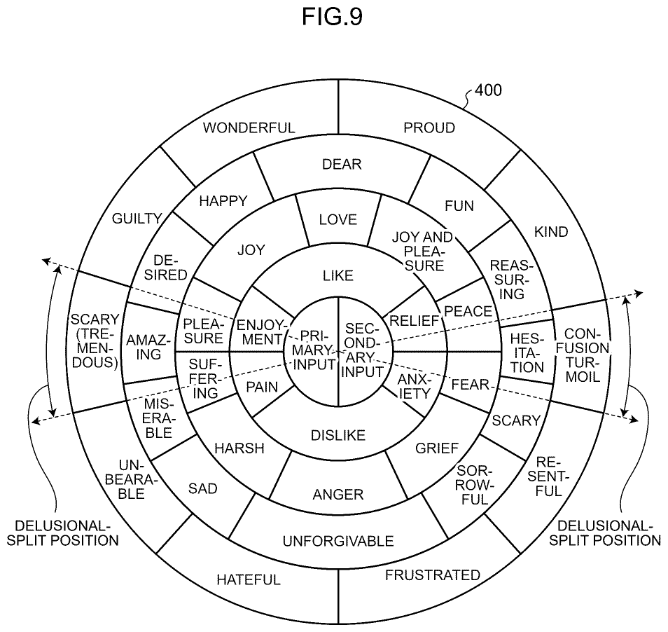

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

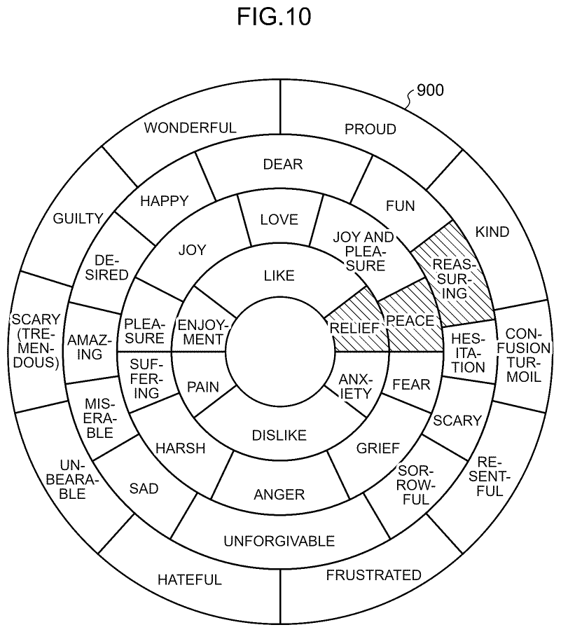

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above.

Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: a collection unit that collects the state of a user; an analysis unit that analyzes data collected by the collection unit; a decision unit that determines an appropriate operation based on the analysis result obtained by the analysis unit; and an execution unit that executes the operation determined by the decision unit.

2. The system according to claim 1, wherein the analysis unit comprises a learning unit that learns the user's behavior patterns.

3. The system according to claim 1, wherein the collection unit comprises an encryption unit that encrypts data collected by a camera.

4. The system according to claim 1, wherein the collection unit comprises a consent acquisition unit that obtains the user's consent.

5. The system according to claim 1, wherein the execution unit performs music playback.

6. The system according to claim 1, wherein the execution unit performs lighting adjustment.

7. The system according to claim 1, wherein the collection unit estimates the user's emotion and adjusts the timing of data collection based on the estimated user emotion.

8. The system according to claim 1, wherein the collection unit analyzes the user's past behavior history and selects an appropriate data collection method.
